(19) United States
(12) Patent Application Publication
(10) Pub. No.: US 2019/0144037 A1
(43) Pub. Date: May 16, 2019

(54) PARKING EVALUATION DEVICE

(71) Applicant: AISIN SEIKI KABUSHIKI KAISHA, Kariya-shi, Aichi (JP)

(72) Inventor: Kotaro YOSHIMURA, Toyohashi-shi (JP)

(73) Assignee: AISIN SEIKI KABUSHIKI KAISHA, Kariya-shi, Aichi (JP)

(21) Appl. No.: 16/307,061

(22) PCT Filed: Mar. 2, 2017
(86) PCT No.: PCT/JP2017/008278

§ 371 Date: Dec. 4, 2018

(30) Foreign Application Priority Data
Jun. 8, 2016 (JP) 2016-114615

(51) Int. Cl. B62D 15/02; G09B 19/16; G08G 1/16

(52) U.S. Cl. CPC B62D 15/028; G08G 1/168; G09B 19/167

(57) ABSTRACT

A parking evaluation device includes: a parking target position setting unit configured to set a parking target position; a parking path calculator configured to calculate a parking path to the parking target position; an own vehicle position calculator configured to calculate an own vehicle position that is a position of a vehicle during a parking operation by a driver; a difference calculator configured to calculate a path difference indicating a difference between the own vehicle position and the parking path; and an output controller configured to inform of first evaluation information on the parking operation, during the parking operation, the first evaluation information being based on the path difference.

### TECHNICAL FIELD

The present invention relates to a parking evaluation device.

### BACKGROUND ART

Parking evaluation devices are known that evaluate a parking operation of a vehicle. For example, such a parking evaluation device detects a parking target position from captured images and determines a parking path to the parking target position. The parking evaluation device evaluates the parking operation based on, for example, the number of times the steering wheel is turned during the course of the parking operation and on a comparison between the actual parking position of the vehicle and the parking target position, and informs the driver of the evaluation result after the vehicle is parked.

### CITATION LIST

### Patent Literature

Patent Document 1: Japanese Patent Application Laid-open No. 2007-216809

Patent Document 2: Japanese Patent Application Laid-open No. 2011-251660

### SUMMARY OF INVENTION

### Problem to be Solved by the Invention

However, the parking evaluation device described above cannot effectively improve the parking operation of the driver because the parking evaluation device informs of the evaluation result only after the vehicle is parked.

### Means for Solving Problem

In order to solve the above problem, a parking evaluation device according to the present invention includes: a parking target position setting unit configured to set a parking target position; a parking path calculator configured to calculate a parking path to the parking target position; an own vehicle position calculator configured to calculate an own vehicle position that is a position of a vehicle during a parking operation by a driver; a difference calculator configured to calculate a path difference indicating a difference between the own vehicle position and the parking path; and an output controller configured to inform of first evaluation information on the parking operation, during the parking operation, the first evaluation information being based on the path difference.

With this, the parking evaluation device informs of the first evaluation information based on the path difference between the ideal parking path and the actual path during the parking operation, so that it is possible to allow the driver in the course of the parking operation to know whether his or her parking operation is appropriate, which can in turn improve the parking operation of the driver.

In the above parking evaluation device, the parking evaluation device according to the present invention may further include a determination unit configured to determine whether the parking operation is ended, and the parking path calculator may be configured not to recalculate the parking path unless the determination unit determines that the parking operation is ended. With this, the parking evaluation device evaluates the parking operation without recalculating the ideal parking path that has been calculated once, so that calculation processes can be reduced.

In the above parking evaluation device, the parking evaluation device according to the present invention may further include a determination unit configured to determine whether the parking operation is ended, and the output controller may inform of second evaluation information relating to a cause of the path difference after the parking operation is ended. With this, the parking evaluation device informs of the second evaluation information indicating a cause of the path difference after the parking operation, so that the parking operation of the driver can be further improved.

In the above parking evaluation device, the output controller of the parking evaluation device according to the present invention may be configured to include, in the second evaluation information, at least one of a steering direction, a steering amount, and steering timing of a steering part configured to turn a wheel of the vehicle as the cause of the path difference. With this, the parking evaluation device informs of the steering direction, steering amount, and steering timing of the steering part as a cause of the path difference, so that the driver can be provided with a more specific advice after the parking operation.

In the above parking evaluation device, the output controller of the parking evaluation device according to the present invention may be configured to include, in the first evaluation information, at least one of a steering direction and a steering amount of a steering part, with which the path difference is reduced, the steering part being configured to turn a wheel of the vehicle. With this, the parking evaluation device informs of the steering direction and steering amount with which the path difference is reduced, in the first evaluation information during the parking operation, so that the driver can be provided with more specific information during the parking operation.

### BRIEF DESCRIPTION OF DRAWINGS

FIG. 1 is an exemplary perspective view of a vehicle according to an embodiment of the present invention through which a part of a vehicle cabin is seen;

FIG. 2 is an exemplary plan view of the vehicle according to the embodiment;

FIG. 3 is a block diagram illustrating a configuration of the vehicle according to the embodiment;

FIG. 4 is a block diagram illustrating functions of an electronic control unit (ECU);

FIG. 5 is a flow chart of a parking evaluation process performed by the ECU;

FIG. 6 is a plan view illustrating a parking operation of the vehicle during the parking evaluation process;

FIG. 7 is a diagram illustrating an example of an image of evaluation information during the parking operation;

FIG. 8 is a diagram illustrating another example of the image of the evaluation information during the parking operation; and

FIG. 9 is a diagram illustrating an example of evaluation information displayed after the parking operation.

### DESCRIPTION OF EMBODIMENTS

Exemplary embodiments and modifications described below include similar components. Such similar components are similarly numbered and explanations thereof are partially omitted. Components included in the embodiments and modifications can be replaced with corresponding components of other embodiments or modifications. Configurations, positions, and other properties of the components of the embodiments and modifications are the same as those of other embodiments and modifications unless otherwise specified.

### Embodiment

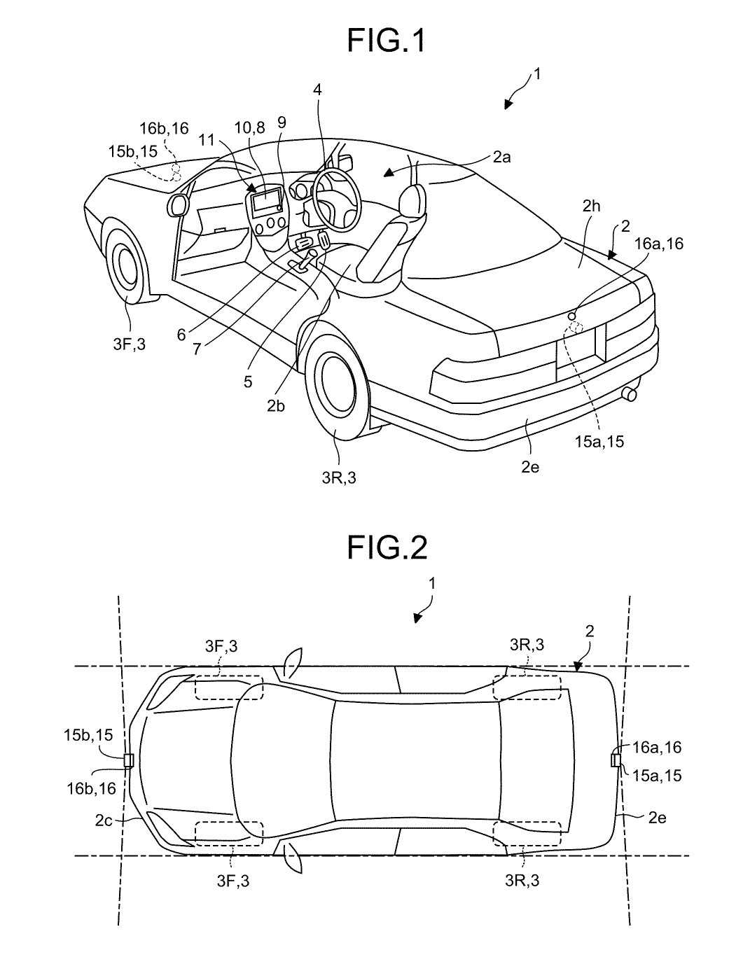

FIG. 1 is an exemplary perspective view of a vehicle 1 according to an embodiment of the present invention through which a part of a vehicle cabin 2a is seen. The vehicle 1 may be, for example, an automobile propelled by an internal combustion engine (not illustrated), that is, an internal combustion engine automobile, an automobile propelled by a motor (not illustrated), that is, for example, an electric automobile or a fuel cell automobile, or an automobile propelled by both of the above, that is, a hybrid automobile. The vehicle 1 can include various types of transmissions and can include various devices (e.g., systems, parts) necessary for driving the internal combustion engine or the motor. The types, number, layouts, and other properties of devices associated with the drive of wheels 3 of the vehicle 1 can be set in various ways.

As illustrated in FIG. 1, the vehicle 1 includes a vehicle body 2, a steering part 4, an accelerator part 5, a braking part 6, a transmission part 7, and a monitor 11.

The vehicle body 2 defines the vehicle cabin 2a that accommodates passengers, which are not illustrated. In the vehicle cabin 2a, for example, the steering part 4, the accelerator part 5, the braking part 6, the transmission part 7, a display device 8, a sound output device 9, and an operation input unit 10 are disposed facing a seat 2b of a driver as a passenger.

The steering part 4 is, for example, a steering wheel protruding from a dashboard. The steering part 4 is configured to turn the wheels 3 of the vehicle 1. The accelerator part 5 is, for example, an accelerator pedal disposed at the feet of the driver. The braking part 6 is, for example, a brake pedal disposed at the feet of the driver. The transmission part 7 is, for example, a shift lever projecting from a center console. The steering part 4, the accelerator part 5, the braking part 6, and the transmission part 7 are not limited to the examples above.

The monitor 11 is disposed at, for example, a center portion of the dashboard in the transverse direction of the vehicle, that is, at the center between the right and left sides of the vehicle. The monitor 11 may have, for example, a function of a navigation system or an audio system. The monitor 11 includes the display device 8, the sound output device 9, and the operation input unit 10. The monitor 11 may include operation input units such as a switch, a dial, a joystick, and push buttons, which are not illustrated.

The display device 8 displays an image based on image information. The display device 8 is, for example, a liquid crystal display (LCD) or an organic electroluminescent display (OELD).

The sound output device 9 outputs sound based on sound data. The sound output device 9 is, for example, a speaker. The sound output device 9 may be disposed at other positions in the vehicle cabin 2a than the monitor 11.

The operation input unit 10 receives inputs from passengers. The operation input unit 10 is, for example, a touch panel. The operation input unit 10 is disposed on a display screen of the display device 8. The operation input unit 10 is configured to transmit therethrough an image displayed on the display device 8. This configuration allows the passengers to view the image displayed on the display screen of the display device 8. The operation input unit 10 receives an instruction input by a passenger touching a position corresponding to an image displayed on the display screen of the display device 8.

FIG. 2 is an exemplary plan view of the vehicle 1 according to the embodiment. As illustrated in FIGS. 1 and 2, the vehicle 1 is, for example, a four-wheel automobile and includes two right and left front wheels 3F and two right and left rear wheels 3R. All or some of the four wheels 3 can be turned.

The vehicle 1 includes a plurality of imaging units 15. The imaging units 15 are, for example, digital cameras including an imaging device such as a charge coupled device (CCD) or a CMOS image sensor (CIS). The imaging units 15 can output video data having a certain frame rate as captured image data. For example, the imaging units 15 output captured image data of the periphery of the vehicle 1. The imaging units 15 each include a wide-angle lens or a fish-eye lens. The imaging units 15 are set with their optical axis inclined downward. With this setting, the imaging units 15 output captured image data of the environment around the vehicle body 2 including the road surface on which the vehicle 1 can move and the region in which the vehicle 1 can park.

The vehicle 1 according to the present embodiment includes two imaging units 15a and 15b. The imaging unit 15a is disposed at, for example, a rear end 2e of the vehicle body 2 and is attached to a lower wall portion of a door 2h of a rear trunk. The imaging unit 15a captures the environment at the rear of the vehicle 1. The imaging unit 15b is disposed at, for example, a front end 2c of the vehicle body 2 and is attached to, for example, a front bumper. The imaging unit 15b captures the environment in front of the vehicle 1. The vehicle 1 may include three or more imaging units 15. In this case, the imaging units 15 may be attached to, for example, the right and left sides of the vehicle body 2.

The vehicle 1 includes a plurality of sonar sensors 16. The sonar sensors 16, for example, emit detection pulses such as ultrasonic pulses and receive the pulses reflected from objects such as other vehicles or obstacles around the vehicle 1 to measure the distances to these measurement targets. The sonar sensors 16 then transmit distance information on the distances to the measurement targets. The sonar sensors 16 may calculate a distance and transmit it as distance information, or may transmit, as distance information, emission time and reception time of the detection pulses necessary for calculating the distance. The distance information transmitted from the sonar sensors 16 is used to detect objects around the vehicle 1 and is also used to generate distance images with captured images of objects around the vehicle 1.

The vehicle 1 includes, for example, two sonar sensors 16a and 16b. The sonar sensor 16a is disposed at, for example, the rear end 2e of the vehicle body 2 and is attached to the lower wall portion of the door 2h of the rear trunk. The sonar sensor 16a generates distance information on a measurement target at the rear of the vehicle 1. The sonar sensor 16b is disposed at, for example, the front end 2c of the vehicle body 2, and is attached to, for example, the front bumper. The sonar sensor 16b generates distance information on a measurement target in front of the vehicle 1.

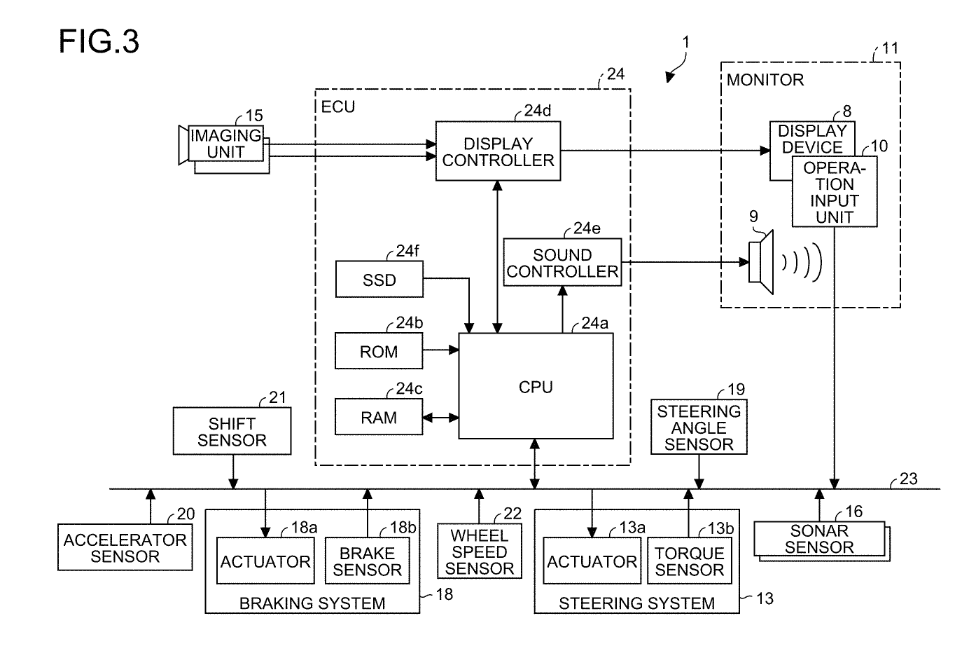

FIG. 3 is a block diagram illustrating a configuration of the vehicle 1 according to the embodiment. As illustrated in FIG. 3, the vehicle 1 further includes a steering system 13, a braking system 18, a steering angle sensor 19, an accelerator sensor 20, a shift sensor 21, a wheel speed sensor 22, an on-board network 23, and an ECU 24. The monitor 11, the steering system 13, the imaging units 15, the sonar sensors 16, the braking system 18, the steering angle sensor 19, the accelerator sensor 20, the shift sensor 21, the wheel speed sensor 22, and the ECU 24 function as a parking evaluation system.

The operation input unit 10, the steering system 13, the sonar sensors 16, the braking system 18, the steering angle sensor 19, the accelerator sensor 20, the shift sensor 21, the wheel speed sensor 22, and the ECU 24 are electrically connected via the on-board network 23, which is a telecommunication line. The on-board network 23 is configured as, for example, a controller area network (CAN).

The steering system 13 is, for example, an electric power steering system or a steer-by-wire (SBW) system. The steering system 13 includes an actuator 13a and a torque sensor 13b. The steering system 13 is electrically controlled by, for example, the ECU 24 to operate the actuator 13a. In the steering system 13, the actuator 13a adds torque such as assist torque to the steering part 4 to augment steering power and turns the wheels 3. In this case, the actuator 13a may turn one wheel 3 or may turn a plurality of wheels 3. The torque sensor 13b detects, for example, an amount of torque applied by the driver to the steering part 4. The torque sensor 13b transmits the torque to the ECU 24.

The braking system 18 includes, for example, an anti-lock braking system (ABS) that prevents the wheels from being locked up during braking, an electronic stability control (ESC) that prevents skidding of the vehicle 1 during cornering, an electronic braking system that assists in braking by augmenting the braking force, and brake-by-wire (BBW). The braking system 18 includes an actuator 18a and a brake sensor 18b. The braking system 18 is electrically controlled by, for example, the ECU 24 and applies a braking force to the wheels 3 via the actuator 18a. The braking system 18 can detect phenomena such as a locked state of the wheels 3 during braking, spinning of wheels 3, and signs of skidding from, for example, the difference in rotational speed of the right and left wheels 3. Upon such detection, the braking system 18 can perform various controls. The brake sensor 18b is, for example, a displacement sensor configured to detect the position of the brake pedal that is a movable member of the braking part 6. The brake sensor 18b transmits the position of the brake pedal to the ECU 24.

The steering angle sensor 19 is configured to detect, for example, a steering amount of the steering part 4 such as the steering wheel. The steering angle sensor 19 detects the rotational angle of a rotating member of the steering part 4 as a steering amount. The steering angle sensor 19 includes, for example, a Hall-effect device. The steering angle sensor 19 transmits, to the ECU 24, steering angle information including, for example, the steering amount of the steering part 4 turned by the driver and the steering amount of the wheels 3 during automatic steering control.

The accelerator sensor 20 is, for example, a displacement sensor configured to detect the position of the accelerator pedal that is a movable member of the accelerator part 5. The accelerator sensor 20 transmits the position of the accelerator part 5 to the ECU 24.

The shift sensor 21 is configured to detect, for example, the position of a movable member of the transmission part 7. The shift sensor 21 detects the position of the movable member of the transmission part 7, such as a lever, an arm, and a button. The shift sensor 21 may include a displacement sensor or may be configured as a switch. The shift sensor 21 transmits the position of the movable member of the transmission part 7 to the ECU 24 as shift information.

The wheel speed sensor 22 is configured to detect the amount of rotation of the wheels 3 and the rotation rate of the wheels 3 per certain unit time. The wheel speed sensor 22 includes, for example, a Hall-effect device. The wheel speed sensor 22 transmits the number of wheel speed pulses indicating the detected rotation rate to the ECU 24 as wheel speed information. The wheel speed sensor 22 may be provided to the braking system 18.

The ECU 24 is an example of the parking evaluation device. The ECU 24 transmits control signals via the on-board network 23 to control the steering system 13 and the braking system 18. The ECU 24 receives detection results from the torque sensor 13b, the brake sensor 18b, the steering angle sensor 19, the sonar sensors 16, the accelerator sensor 20, the shift sensor 21, and the wheel speed sensor 22 via the on-board network 23. The ECU 24 receives captured image data from the imaging units 15. The ECU 24 may receive the captured image data from the imaging units 15 via the on-board network 23. The ECU 24 is, for example, a computer. The ECU 24 includes a central processing unit (CPU) 24a, a read only memory (ROM) 24b, a random access memory (RAM) 24c, a display controller 24d, a sound controller 24e, and a solid-state drive (SSD) 24f. The CPU 24a, the ROM 24b, and the RAM 24c may be integrated in the same package.

The CPU 24a reads a computer program stored in a non-volatile storage device such as the ROM 24b and performs various types of calculation processing and control in accordance with the computer program. For example, the CPU 24a performs image processing on an image to be displayed on the display device 8, calculates an own vehicle position, calculates the distance to a measurement target, sets a parking target position, calculates an ideal parking path from the own vehicle position to the parking target position, and performs parking evaluation for the driver.

The ROM 24b stores therein, for example, computer programs and parameters necessary for executing the computer programs. The RAM 24c temporarily stores therein various types of data for use in calculation by the CPU 24a. The display controller 24d mainly performs, among calculations performed in the ECU 24, processing on the captured images received from the imaging units 15 to be output to the CPU 24a and converts image data received from the CPU 24a into an image to be displayed on the display device 8. The sound controller 24e mainly performs, among the calculations performed in the ECU 24, processing on the sound received from the CPU 24a to be output to the sound output device 9. The SSD 24f is a rewritable non-volatile storage device. When the ECU 24 is powered off, the SSD 24f retains data received from the CPU 24a.

In the present embodiment, the ECU 24 performs the entire control of the vehicle 1 by use of hardware and software (control programs). For example, the ECU 24 sets an ideal parking path to the parking target position that has been set based on, for example, detection information from the sonar sensors 16. The ECU 24 calculates a path difference indicating a difference in positions between an own vehicle position during the parking operation by the driver and the ideal parking path to evaluate the parking operation of the driver. With this configuration, the ECU 24 functions as the parking evaluation device.

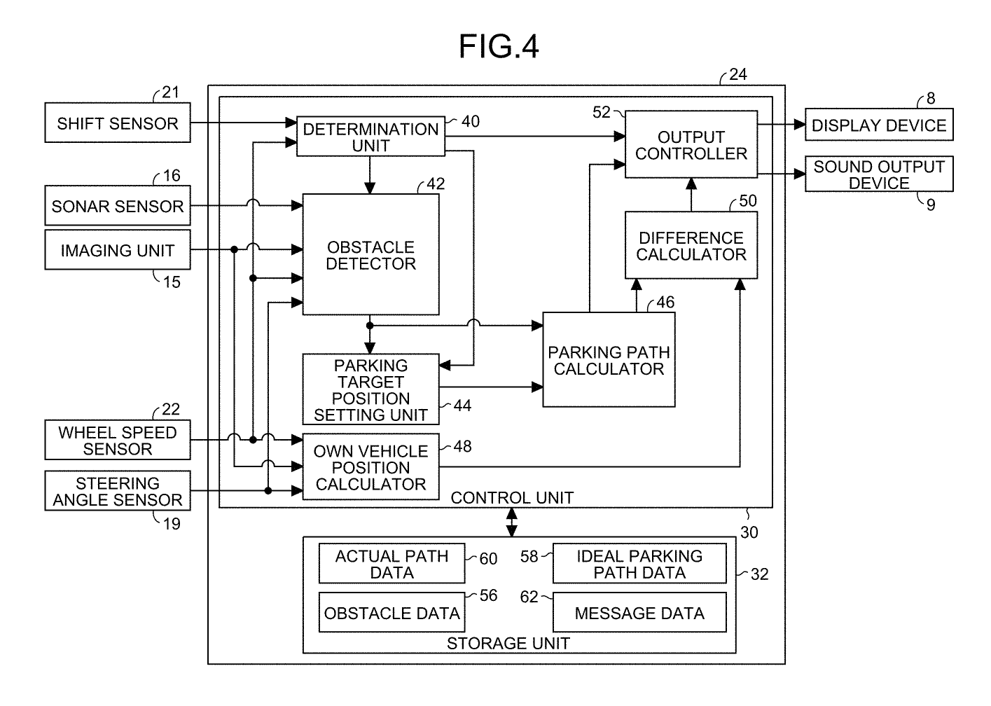

FIG. 4 is a block diagram illustrating functions of the ECU 24. As illustrated in FIG. 4, the ECU 24 includes a control unit 30 and a storage unit 32. The control unit 30 is a functional unit implemented by the CPU 24a, the display controller 24d, and the sound controller 24e. The storage unit 32 is a functional unit implemented by the ROM 24b, the RAM 24c, and the SSD 24f.

The control unit 30 includes a determination unit 40, an obstacle detector 42, a parking target position setting unit 44, a parking path calculator 46, an own vehicle position calculator 48, a difference calculator 50, and an output controller 52. For example, the CPU 24a executes a computer program for the parking evaluation process stored in the ROM 24b or the SSD 24f and the ECU 24 implements the functions of the determination unit 40, the own vehicle position calculator 48, the obstacle detector 42, the parking target position setting unit 44, the parking path calculator 46, the difference calculator 50, and the output controller 52. Some or all of the determination unit 40, the own vehicle position calculator 48, the obstacle detector 42, the parking target position setting unit 44, the parking path calculator 46, the difference calculator 50, and the output controller 52 may be configured by hardware such as a circuit.

The determination unit 40 receives shift information from the shift sensor 21. The determination unit 40 receives wheel speed information from the wheel speed sensor 22. The determination unit 40 determines whether the driver is intending to park, the parking operation is started, and the parking operation is ended based on the shift information and the wheel speed information. The determination unit 40 may receive vehicle speed information from an external system and determine the driver's intention to park, starting of the parking operation, and end of the parking operation based on the vehicle speed information.

Specifically, if the speed of the vehicle 1 drops below a predetermined threshold speed, the determination unit 40 determines, based on the wheel speed information, that the driver has an intention to park. The determination unit 40 outputs the determination result indicating the driver's parking intention to the obstacle detector 42. When the vehicle 1 is shifted to reverse from drive, the determination unit 40 determines, based on the shift information, that the parking operation is started. The determination unit 40 outputs the determination result indicating that the parking operation is started to the parking target position setting unit 44. If the vehicle 1 is shifted from drive (e.g., D) to reverse (e.g., R) and starts moving, the determination unit 40 determines that the vehicle 1 is in the parking operation. If the vehicle 1 is shifted to park from drive or reverse after the determination unit 40 determines that the vehicle 1 is in the parking operation, the determination unit 40 determines, based on the shift information, that the parking operation is ended. The determination unit 40 outputs the determination result indicating that the parking operation is ended to the output controller 52.

The obstacle detector 42 receives wheel speed information from the wheel speed sensor 22. The obstacle detector 42 receives steering angle information from the steering angle sensor 19. The obstacle detector 42 receives distance information from the sonar sensors 16. Upon receiving the determination result indicating that the driver is intending to park from the determination unit 40, the obstacle detector 42 detects obstacles in and around the direction of the vehicle 1 based on the wheel speed information, the steering angle information, and the distance information and based on predetermined obstacle data 56 stored in the storage unit 32. The obstacle detector 42 may receive captured image data from the imaging units 15 and detect obstacles based on any of the pieces of information above and the captured image data. The obstacle detector 42 may receive distance information from a laser-emitting distance measuring sensor and detect obstacles. The obstacle detector 42 outputs the detected obstacle information to the parking target position setting unit 44 and the parking path calculator 46.

Upon receiving the determination result indicating that the parking operation is started from the determination unit 40, the parking target position setting unit 44 sets a parking target position that is a position targeted by the vehicle 1 in the parking operation. For example, the parking target position setting unit 44 sets, based on the obstacle information, a region with no obstacles that may interrupt the parking operation and thus available to the vehicle 1 to park as the parking target position. The parking target position setting unit 44 outputs the set parking target position to the parking path calculator 46.

The parking path calculator 46 calculates and sets an ideal parking path that is an ideal parking trajectory to the parking target position based on the obstacle information and the parking target position. For example, the parking path calculator 46 calculates the distance to the parking target position and determines which of the known models to use, such as an ark model, a straight line model, and a two-circle model with regard to the distance and sets an ideal parking path in which no obstacles are present. If an ark model is used, the parking path calculator 46 sets an ideal parking path having an ark shape of a single circle. If a straight-line model is used, the parking path calculator 46 sets an ideal parking path having a combined shape of a straight line and an ark of a single circle. If a two-circle model is used, the parking path calculator 46 sets an ideal parking path having a combined shape of two arks of two circles in different rotational direction (e.g., clockwise and counterclockwise). The parking path calculator 46 may set an ideal parking path having a combined shape of arks of a plurality of circles and a straight line. The parking path calculator 46 outputs the set ideal parking path data 58 to the difference calculator 50 and to the output controller 52 and stores the data in the storage unit 32.

The own vehicle position calculator 48 receives captured image data from the imaging units 15 (e.g., imaging unit 15a). The own vehicle position calculator 48 calculates, based on the captured image data, a vehicle position that is a position of the vehicle 1 during the parking operation by the driver. The own vehicle position calculator 48 may receive wheel speed information from the wheel speed sensor 22 and receive steering angle information from the steering angle sensor 19 and calculate, based on the wheel speed information and the steering angle information, the vehicle position during the parking operation. The own vehicle position calculator 48 outputs the calculated own vehicle position to the difference calculator 50. The own vehicle position calculator 48 stores the own vehicle position in the storage unit 32 at, for example, a predetermined interval of time or distance. The own vehicle position calculator 48 stores actual path data 60 that is an actual trajectory of the vehicle 1 during the parking operation by the driver in the storage unit 32.

The difference calculator 50 calculates a path difference indicating a difference between an own vehicle position during the parking operation and the ideal parking path. For example, the difference calculator 50 calculates the distance between an own vehicle position and a position on the ideal parking path closest to the own vehicle position. The difference calculator 50 outputs the calculated path difference to the output controller 52.

The output controller 52 evaluates the parking operation by the driver based on the path difference received from the difference calculator 50 and informs of evaluation information (corresponding to the first evaluation information) on the parking operation based on the path difference, during the parking operation. For example, if the path difference is equal to or larger than a predetermined evaluation threshold, the output controller 52 determines that the parking operation is inappropriate and informs of evaluation information indicating that the parking operation is inappropriate. The evaluation threshold may be zero. In this case, even a small deviation of the own vehicle position from the ideal parking path causes the output controller 52 to determine that the parking operation is inappropriate. The output controller 52 may include correction information indicating how the parking operation should be corrected in the evaluation information during the parking operation. Examples of the correction information include at least one of a steering direction and a steering amount of the steering part 4 with which the path difference is reduced. In this case, if the steering amount of the steering part 4 is insufficient, the output controller 52 informs of correction information indicating that the driver should turn the steering part 4 further in the current steering direction by such a steering amount to compensate for the shortage of the steering amount. When the steering amount of the steering part 4 is excessive, the output controller 52 informs of correction information indicating that the driver should turn the steering part 4 in the counter direction of the current steering direction by such a steering amount to reduce the excess steering amount. The output controller 52 informs of the evaluation information during the parking operation by causing the display device 8 to display an image or causing the sound output device 9 to output sound based on predetermined message data 62 stored in the storage unit 32.

Upon receiving the determination result indicating that the parking operation is ended from the determination unit 40, the output controller 52 may inform of evaluation information (corresponding to the second evaluation information) after the parking operation by using an image or sound. The output controller 52 may include an advice on the cause of the path difference in the evaluation information after the parking operation. The output controller 52 may include, in the evaluation information, at least one of the steering direction, steering amount, and steering timing of the steering part 4 as an advice on the cause of the path difference after the parking operation. The path difference referred to herein includes a difference between the actual parking position after the parking operation and the parking target position. Specifically, if the actual parking position deviates from the parking target position in the transverse direction, the output controller 52 informs of, for example, inappropriate timing at the start of steering and shortage or excess of a steering amount as an advice on the cause of the path difference.

The output controller 52 may determine the difficulty of the ideal parking path received from the parking path calculator 46 based on, for example, the number of times the steering part 4 is turned, and may inform of the difficulty by using an image or sound before the driver starts the parking operation. For example, the output controller 52 determines the ideal parking path to be easy when the number of times the steering part 4 is turned is zero, determines the ideal parking path to be neither easy or difficult when the number is one or two, and determines the ideal parking path to be difficult when the number is three or more.

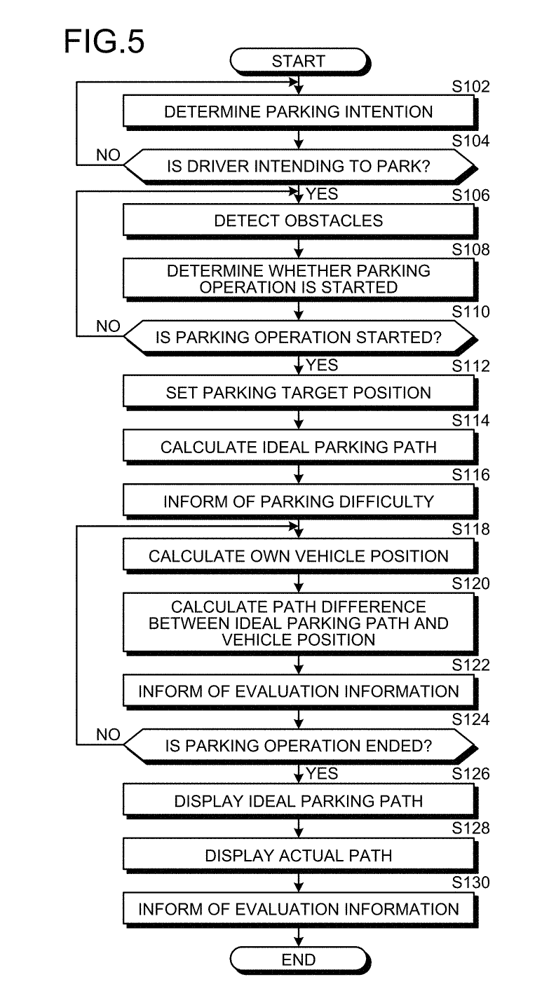

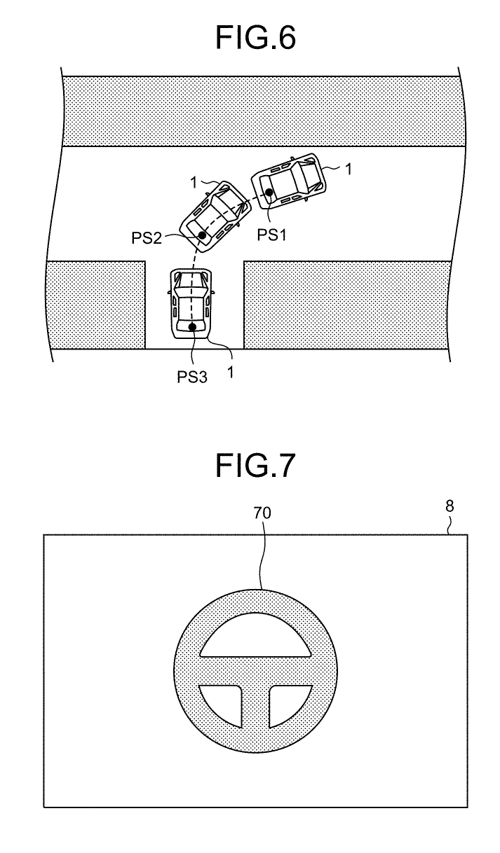

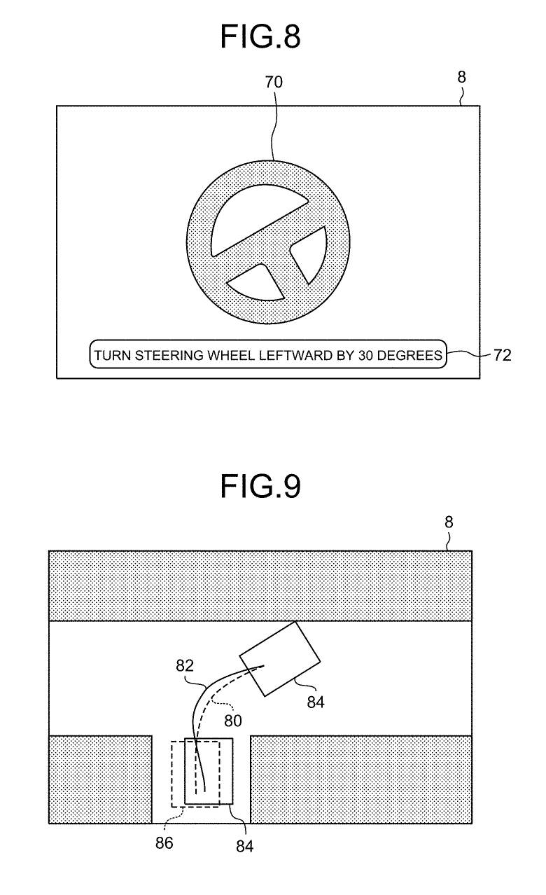

FIG. 5 is a flow chart of a parking evaluation process performed by the ECU 24. FIG. 6 is a plan view illustrating a parking operation of the vehicle 1 during the parking evaluation process. FIGS. 7 and 8 are diagrams illustrating an example of an image of evaluation information during a parking operation. FIG. 9 is a diagram illustrating an example of evaluation information displayed after the parking operation. The CPU 24a reads the computer program for the parking evaluation process stored in the ROM 24b and then the ECU 24 performs the parking evaluation process.

In the parking evaluation process as illustrated in FIG. 5, the determination unit 40 determines, based on the wheel speed information, whether the driver is intending to park (S102). If the determination unit 40 determines that the driver has no intention to park (No at S104), Step S102 is repeated. If the speed of the vehicle 1 drops below a threshold speed, the determination unit 40 determines, based on the wheel speed information, that the driver has an intention to park (Yes at S104) and outputs the determination result to the obstacle detector 42.

The obstacle detector 42 detects obstacles around the vehicle 1 based on the distance information from the sonar sensors 16, the wheel speed information from the wheel speed sensor 22, the steering angle information from the steering angle sensor 19, and the obstacle data 56 in the storage unit 32 (S106). The obstacle detector 42 outputs the detected obstacle information to the parking target position setting unit 44 and the parking path calculator 46.

The determination unit 40 determines, based on the shift information, whether the parking operation is started (S108). The determination unit 40 repeats the process at Step S106 and the subsequent processes until the determination unit 40 determines that the parking operation is started (No at S110). When the vehicle 1 is stopping at a position PS1 illustrated in FIG. 6 and the vehicle 1 is shifted from drive to reverse, the determination unit 40 determines, based on the shift information, that the parking operation is started (Yes at 5110) and outputs the determination result to the parking target position setting unit 44.

Upon receiving the determination result from the determination unit 40 indicating that the parking operation is started, the parking target position setting unit 44 detects a region available to the vehicle 1 to park and sets a parking target position, on the basis of the obstacle information received from the obstacle detector 42 (S112). The parking target position setting unit 44 outputs the parking target position to the parking path calculator 46.

Upon receiving the parking target position from the parking target position setting unit 44, the parking path calculator 46 calculates and sets an ideal parking path that is an ideal parking trajectory on the basis of the obstacle information and the parking target position (S114). The parking path calculator 46 outputs the set ideal parking path to the difference calculator 50 and to the output controller 52 and stores the ideal parking path in the storage unit 32.

Upon receiving the ideal parking path from the parking path calculator 46, the output controller 52 informs of the parking difficulty (S116).

The own vehicle position calculator 48 calculates, based on the captured image data from the imaging units 15 (e.g., the imaging unit 15a), an own vehicle position of the vehicle 1, such as a position PS2 in FIG. 6, during the parking operation (S118). The own vehicle position calculator 48 may calculate the vehicle position based on the wheel speed information from the wheel speed sensor 22 and the steering angle information from the steering angle sensor 19. The own vehicle position calculator 48 outputs the own vehicle position to the difference calculator 50 and stores the vehicle position in the storage unit 32.

The difference calculator 50 calculates a path difference between the ideal parking path and the own vehicle position (S120). The difference calculator 50 outputs the path difference to the output controller 52.

Upon receiving the path difference, the output controller 52 informs of evaluation information on the parking operation that has been evaluated based on the path difference (S122). Since the process at Step S122 is performed during the parking operation, the output controller 52 informs of the evaluation information during the parking operation. For example, if the path difference is equal to or larger than an evaluation threshold, the output controller 52 determines that the parking operation is inappropriate and informs evaluation information based on the massage data 62 by using an image or sound. The output controller 52 may include, in the evaluation information, for example, correction information indicating how to correct the parking operation. For example, the output controller 52 includes, in the evaluation information, instructions as correction information, the instructions relating to the steering amount and the steering direction of the steering part 4 (whether the steering part 4 should be turned in the same direction or reverse direction) to bring the vehicle 1 from the current own vehicle position to the ideal parking path. When the output controller 52 outputs the correction information relating to the steering amount as an image, the output controller 52 causes the display device 8 to display a steering wheel image 70 that is an image of a steering wheel illustrated in FIG. 7 and then to switch images and display another steering wheel image 70 illustrated in FIG. 8 illustrating a steering wheel turned at an angle corresponding to the steering amount, and to display a message 72 indicating a specific steering amount. The output controller 52 may cause the display device 8 to display a video of the steering wheel image 70 illustrated in FIG. 7 turning at a rotation speed associated with a steering amount of the steering part 4 that is an ideal steering amount to bring the vehicle 1 into the ideal parking path. The output controller 52 then may switch images to the steering wheel image 70 illustrated in FIG. 8.

The determination unit 40 determines, based on the shift information, whether the parking operation is ended (S124). If the determination unit 40 determines that the parking operation is not ended (No at S124), the process at Step S118 and the subsequent processes are repeated. This configuration allows the output controller 52 to inform of the evaluation information a plurality of times during the parking operation. The ECU 24 is configured not to repeat the processes at or before Step S116 including Step S114 at which the ideal parking path is calculated. The parking path calculator 46, if it has calculated the ideal parking path once, is configured not to recalculate the ideal parking path unless the determination unit 40 determines that the parking operation is ended.

When the vehicle 1 stops at a position PS3 in FIG. 6 and is shifted from reverse to park, the determination unit 40 determines, based on the shift information, that the parking operation is ended (Yes at S124), and the determination unit 40 outputs the determination result to the output controller 52.

Upon receiving the determination result indicating that the parking operation is ended, the output controller 52 causes the display device 8 to display an ideal parking path image 80 that is an image of an ideal parking trajectory indicated by the dashed line in FIG. 9 based on the ideal parking path data 58 in the storage unit 32 (S126). The output controller 52 causes the display device 8 to display an actual path image 82 that is an image of the actual trajectory indicated by the solid line in FIG. 9 based on the actual path data 60 stored in the storage unit 32 with being superimposed on the ideal parking path image 80 (S128). The output controller 52 may cause the display device 8 to display the ideal parking path image 80 and the actual path image 82 together with the shape of a road around the vehicle 1, vehicle images 84 at a plurality of actual positions of the vehicle 1 during the parking operation and a parking target position image 86 indicated by a dashed line. The output controller 52 informs of the evaluation information on the parking operation by using an image or sound based on the message data 62 (S130). The output controller 52 may include, for example, an advice for the parking operation in the evaluation information. The output controller 52 may include, in the evaluation information, information such as a steering direction of the steering part 4, shortage or excess of the steering amount of the steering part 4, and deviations of timing at the start or end of turning the steering part 4 as an advice for the future parking operation. The ECU 24 then ends the parking evaluation process.

As described above, since the ECU 24 informs of evaluation information based on the path difference between the ideal parking path and the actual path during the parking operation, this allows the driver performing the parking operation to know whether his or her parking operation is appropriate, which can in turn improve the parking operation of the driver.

The ECU 24 evaluates the parking operation without recalculating the ideal parking path if the ideal parking path has been calculated once, and this can reduce calculation processes.

The ECU 24 informs of evaluation information indicating a cause of a path difference after the parking operation. The evaluation information differs from the evaluation information output during the parking operation, and this can further improve the parking operation of the driver. The ECU 24 can provide the driver with a specific advice after the parking operation by informing of the steering direction, steering amount, and steering timing of the steering part 4 as the cause of the path difference.

The ECU 24 can provide the driver with more specific correction information during the parking operation by informing of the steering direction and the steering amount of the steering part 4, with which the path difference is reduced, in the evaluation information during the parking operation.

The functions, number, and connecting relation of the configurations of the embodiment above may be changed as appropriate. The order of Steps illustrated in the flow chart according to the embodiment above may be changed as appropriate.

For example, the output controller 52 may inform of evaluation information by using an alarm sound when the path difference reaches or exceeds a threshold during the parking operation.

Although embodiments and modifications of the present invention have been described above, the embodiments and modifications are presented for illustrative purposes only and are not intended to limit the scope of the present invention. These novel embodiments can be implemented in various other forms and various omissions, substitutions, and modifications may be made by those skilled in the art without departing from the spirit of the invention. These embodiments and modifications are encompassed within the scope and spirit of the present invention and are intended to fall within the scope of the appended claims and equivalents thereof.

1. A parking evaluation device comprising:
a parking target position setting unit configured to set a parking target position;
a parking path calculator configured to calculate a parking path to the parking target position;
an own vehicle position calculator configured to calculate an own vehicle position that is a position of a vehicle during a parking operation by a driver;
a difference calculator configured to calculate a path difference indicating a difference between the own vehicle position and the parking path; and
an output controller configured to inform of first evaluation information on the parking operation, during the parking operation, the first evaluation information being based on the path difference.

2. The parking evaluation device according to claim 1, further comprising:
a determination unit configured to determine whether the parking operation is ended, wherein
the parking path calculator is configured not to recalculate the parking path unless the determination unit determines that the parking operation is ended.

3. The parking evaluation device according to claim 1, further comprising:
a determination unit configured to determine whether the parking operation is ended, wherein
the output controller informs of second evaluation information relating to a cause of the path difference after the parking operation is ended.

4. The parking evaluation device according to claim 3, wherein the output controller is configured to include, in the second evaluation information, at least one of a steering direction, a steering amount, and steering timing of a steering part configured to turn a wheel of the vehicle as the cause of the path difference.

5. The parking evaluation device according to claim 1, wherein the output controller is configured to include, in the first evaluation information, at least one of a steering direction and a steering amount of a steering part, with which the path difference is reduced, the steering part being configured to turn a wheel of the vehicle.
